(19) United States
(12) Patent Application Publication
(10) Pub. No.: US 2005/0221877 A1
(43) Pub. Date: Oct. 6, 2005

(54) Methods for controlling processing of outputs to a vehicle wireless communication interface

(76) Inventors: Scott B. Davis, Walworth, WI (US); Raymond L. Sokola, Long Grove, IL (US); Michael A. Newell, Williams Bay, WI (US); Robert F. D'Avello, Lake Zurich, IL (US); Nick J. Grivas, Harvard, IL (US); James A. Van Bosch, Crystal Lake, IL (US)

Correspondence Address: MOTOROLA, INC., 1303 EAST ALGONQUIN ROAD, IL01/3RD, SCHAUMBURG, IL, 60196, US

(21) Appl. No.: 10/818,080

(22) Filed: Apr. 5, 2004

(51) Int. Cl. H04Q 7/20

(52) U.S. Cl. 455/575.9

(57) ABSTRACT

Disclosed herein are systems and methods for organizing communications in a vehicular wireless communication system. In one embodiment, methods and systems are disclosed for modifying communications broadcast within a vehicle. In one embodiment, the volume of the broadcast communications are scaled or modified in a manner to indicate the distance of the recipient of the communications. In another embodiment, broadcast communications are selectively broadcast through those speakers that are closest to the recipient of the communications in accordance with the angular orientation of the vehicle to the recipient. In another embodiment, the distance or angular orientation of the recipient is displayed on a user interface in the vehicle. In yet another embodiment, only the speakers are engaged in the vehicle that is nearest to the passenger that initiates the communication with the recipient.

The present application is related to the following co-pending, commonly assigned patent applications, which were filed concurrently herewith and incorporated by reference in their entirety:

Ser. No. ______, entitled “Selectively Enabling Communications at a User Interface Using a Profile,” attorney docket TC00167, filed concurrently herewith.

Ser. No. ______, entitled “Method for Enabling Communications Dependent on User Location, User-Specified Location, or Orientation,” attorney docket TC00168, filed concurrently herewith.

Ser. No. ______, entitled “Methods for Sending Messages Based on the Location of Mobile Users in a Communication Network,” attorney docket TC00169, filed concurrently herewith.

Ser. No. ______, entitled “Methods for Displaying a Route Traveled by Mobile Users in a Communication Network,” attorney docket TC00170, filed concurrently herewith.

Ser. No. ______, entitled “Conversion of Calls from an Ad Hoc Communication Network,” attorney docket TC00172, filed concurrently herewith.

Ser. No. ______, entitled “Method for Entering a Personalized Communication Profile Into a Communication User Interface,” attorney docket TC00173, filed concurrently herewith.

Ser. No. ______, entitled “Methods and Systems for Controlling Communications in an Ad Hoc Communication Network,” attorney docket TC00174, filed concurrently herewith.

Ser. No. ______, entitled “Methods for Controlling Processing of Inputs to a Vehicle Wireless Communication Interface,” attorney docket TC00175, filed concurrently herewith.

Ser. No. ______, entitled “Programmable Foot Switch Useable in a Communications User Interface in a Vehicle,” attorney docket TC00177, filed concurrently herewith.

### FIELD OF THE INVENTION

This invention in general relates to systems and methods for organizing communications in an ad hoc communication network, and more specifically in a vehicle.

### BACKGROUND OF THE INVENTION

Communication systems, and especially wireless communication systems, are becoming more sophisticated, offering consumers improved functionality to communicate with one another. Such increased functionality has been particularly useful in the automotive arena, and vehicles are now being equipped with communication systems with improved audio (voice) wireless communication capabilities. For example, On Star™ is a well-known communication system currently employed in vehicles, and allows vehicle occupants to establish a telephone call with a service center by activating a switch. Additionally, vehicles are now being equipped with hands-free systems that allow a vehicle operator to place a call to a third party, including third parties that are located in another vehicle.

Existing vehicle-to-vehicle communications are relatively crude, and there is room for improvement. For example, two vehicles that are communicating with each other may have multiple occupants. But when each vehicle's user interface is equipped with only a single microphone and speaker(s), communication can become confused. For example, when one occupant in a first vehicle calls a second vehicle, other occupant's voices in the first vehicle will be picked up by the microphone. As a result, the occupants in the second vehicle may become confused as to who is speaking in the first vehicle. Moreover, an occupant in the first vehicle may wish to only speak to a particular occupant in the second vehicle, rather than having his voice broadcast throughout the second vehicle. Similarly, an occupant in the second vehicle may wish to know who in the first vehicle is speaking at a particular time, and may wish to receive communications from only particular occupants in the first vehicle. Additionally, if the vehicles are traveling or “caravanning” together, communication between them would be benefited by a more realistic feel that gave the occupants in vehicles a sense of where each other is located (to the front, to the right, the relative distance between them, etc.).

In short, there is much about the organization of vehicle wireless-based communications systems that could use improvement to enhance its functionality, and to better utilize the resources that the system is capable of providing. This disclosure presents several different means to so improve these communications.

It is, therefore, desirable to provide an improved procedure for organizing communications in an ad hoc communication network, and more specifically in a vehicle.

### BRIEF DESCRIPTION OF THE DRAWINGS

FIG. 1 is a block diagram of a wireless vehicular communications system;

FIG. 2 is a block diagram illustrating one embodiment of a control system for a vehicle according to the present invention;

FIG. 3 is diagram illustrating one embodiment of a vehicle with a steerable microphone for allowing wireless communications;

FIG. 4 is a diagram illustrating another embodiment of a vehicle having a plurality of push-to-talk switches and a plurality of microphones, each preferably incorporated into armrests in the vehicle;

FIG. 5 is a block diagram of one embodiment illustrating a control system for the vehicle of FIG. 4;

FIG. 6 is a block diagram illustrating another embodiment of a control system for a vehicle having a plurality of microphones and incorporating a noise analyzer for determining an active microphone;

FIG. 7 is a block diagram illustrating a further embodiment of a control system for a vehicle having a plurality of microphones and incorporating a beam steering analyzer for determining an active microphone;

FIG. 8 is a block diagram illustrating yet another embodiment of a control system for a vehicle having a user ID module;

FIGS. 9, 10 illustrate a display useable with the control system of FIG. 8, and which allows vehicle occupants to enter their user IDs;

FIG. 11 illustrates a display useable with the control system of FIG. 8, and which allows vehicle occupants to block, modify, or override user IDs received by the control system;

FIG. 12 is a diagram illustrating the positions of and angular orientation between two vehicles in communication;

FIG. 13 is a block diagram illustrating a control system useable by the vehicles of FIG. 12 for determining the locations of the vehicles;

FIG. 14 is a block diagram illustrating a control system useable by the vehicles of FIG. 12 for determining the angular orientation between the vehicles;

FIG. 15 is a diagram illustrating further details concerning determining the angular orientation between the vehicles and for activating certain speakers in accordance therewith; and

FIG. 16 is a diagram illustrating a display in a vehicle user interface for displaying the location and distance of a second vehicle.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is an improved system and procedure for controlling processing of outputs to a vehicle's wireless communication interface. Disclosed herein are systems and methods for organizing communications in a vehicular wireless communication system. In one embodiment, there is a method for broadcasting communications in a vehicle having a plurality of speakers, comprising wirelessly coupling a control unit in the vehicle to a communication network to allow voice communications with another user or push-to-talk (PTT) group coupled to the communication network, determining data indicative of an angle between the trajectory of the vehicle and the position of the other user relative to the vehicle, and selectively engaging the speakers in the vehicle to broadcast the voice communications in accordance with the determined angle so that the broadcast voice substantially correlates with the position of the user relative to the vehicle.

In another embodiment, there is a method for broadcasting communications in a vehicle having at least one speaker, comprising wirelessly coupling a control unit in the vehicle to a communication network to allow voice communications with another user or PTT group coupled to the communication network, determining a distance between the vehicle and the other user, and providing through the at least one speaker the other user's voice, wherein the other user's voice is modified in a manner indicative of the distance to the other user. Moreover, the determined distance may be used to further determine a priority with respect to relative distance of a particular within a PTT group.

In a further embodiment, there is a method for broadcasting communications in a vehicle having a plurality of speakers, comprising having a first user engage a user interface in the vehicle to enable the first user to wirelessly communicate with another user (whether alone or within a PTT group), receiving the other user's voice at the vehicle, and broadcasting the other user's voice through at least one of the plurality of speakers, wherein the broadcasted other user's voice is modified in a manner indicative of either the distance between the vehicle and the other user or the angular orientation between the vehicle and the other user.

In yet another embodiment, there is a method for broadcasting communications in a vehicle having a plurality of speakers, comprising having a first user engage a user interface in the vehicle to enable the first user to wirelessly communicate with another user, receiving the other user's voice at the vehicle, broadcasting the other user's voice through at least one of the plurality of speakers, and displaying the location of the other user by a pointer which points to the location of the other user relative to the location of the vehicle.

In still another embodiment, a method is disclosed for broadcasting communications in a vehicle having a plurality of speakers, comprising having a first user in the vehicle establish a wireless voice communication with a second user, receiving the second user voice data at the first vehicle, determining the location of the first user in the vehicle, and broadcasting the second user's voice data only through at least one of the plurality of speakers that is nearest to the first user.

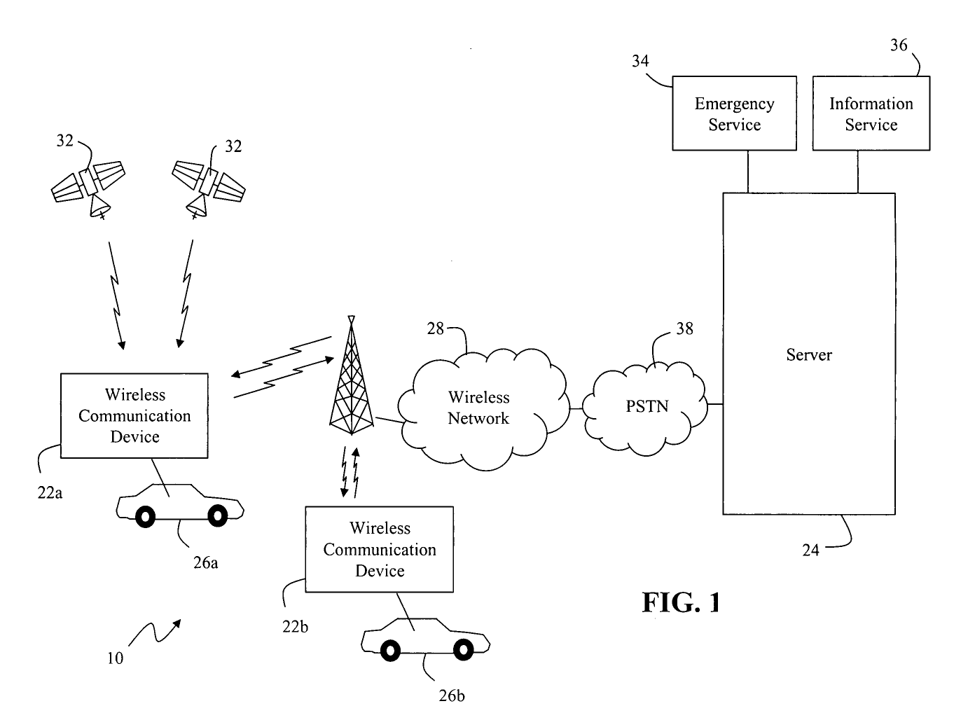

Now, turning to the drawings, an example use of the present invention in an automotive setting will be explained. FIG. 1 shows an exemplary vehicle-based communication system 10. In this system, vehicles 26 are equipped with wireless communication devices 22, which will be described in further detail below. The communication device 22 is capable of both broadcasting and receiving voice (i.e., speech), data (such as textual or SMS data), and/or video. Thus, device 22 can wirelessly transmit or receive any of these types of information to a transceiver or base station coupled to a wireless network 28. Moreover, the wireless communication device may receive information from satellite communications. Ultimately, the network may be coupled to a public switched telephone network (PSTN) 38, the Internet, or other communication network on route to a service center having a server 24, which ultimately acts as the host for communications on the communication system 10 and may comprise a communications server. As well as administering communications between vehicles 26 wirelessly connected to the system, the server 24 can provide other services to the vehicles 26, such as emergency services 34 or other information services 36 (such as restaurant services, directory assistance, etc.).

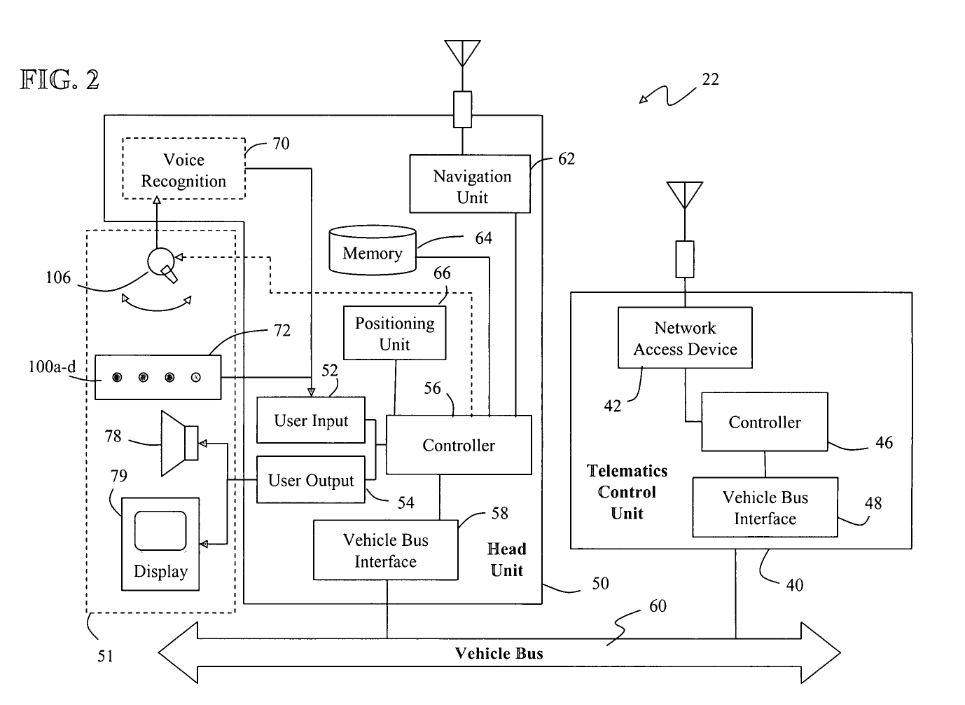

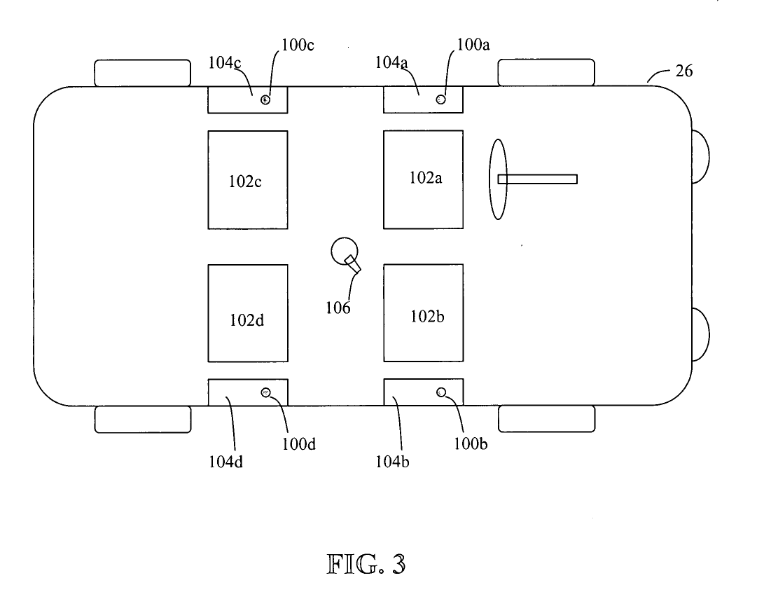

FIGS. 2 and 3 illustrate a means for addressing the problem of a single microphone inadvertently picking up speech of occupants other than those that have engaged the communication system with a desire to speak. Referring to FIG. 2, the device 22 is comprised of two main components: a head unit 50 and a Telematics control unit 40. The head unit 50 interfaces with or includes a user interface 51 with which the vehicle occupants interact when communicating with the system 10 or other vehicles that are wirelessly coupled to the system. For example, in this embodiment, a directional microphone 106 can be used to pick up a speaker's voice in the vehicle, and/or possibly to give commands to the head unit 50 if it is equipped with a voice recognition module 70. A keypad 72 may also be used to provide user input, with switches on the keypad 72 either being dedicated to particular functions (such as a push-to-talk switch, a switch to receive mapping information, etc.) or allowing for selection of options that the user interface provides. In this embodiment, the keypad 72 includes a plurality of push-to-talk (PTT) switches 100a-d that may be located throughout the vehicle 26.

The head unit 50 may also comprise a navigation unit 62, which typically includes a Global Positioning Satellite (GPS) system for allowing the vehicle's location to be pinpointed, which is useful, for example, in associating the vehicle's location with mapping information the system provides. As is known, such a navigation unit communicates with GPS satellites (such as satellites 32) via a receiver. Also present is a positioning unit 66, which determines the direction in which the vehicle is pointing (north, north-east, etc.), and which is also useful for mapping a vehicle's progress along a route.

Ultimately, user and system inputs are processed by a controller 56 which executes processes in the head unit 50 accordingly, and provides outputs 54 to the occupants in the vehicle, such as through a speaker 78 or a display 79 coupled to the head unit 50. The speakers 78 employed can be the audio (radio) speakers normally present in the vehicle, of which there are typically four or more, although only one is shown for convenience. Moreover, in an alternative embodiment, the output 54 may include a text to speech converter to provide the option to hear an audible output of any text that is contained in a group communication channel that the user may be monitoring. This audio feature may be particular advantageous in the mobile environment where the user is operating a vehicle. Additionally, a memory 64 is coupled to the controller 56 to assist it in performing regulation of the inputs and outputs to the system. The controller 56 also communicates via a vehicle bus interface 58 to a vehicle bus 60, which carries communication information and other vehicle operational data throughout the vehicle.

The Telematics control unit 40 is similarly coupled to the vehicle bus 60, via a vehicle bus interface 48, and hence the head unit 50. The Telematics control unit 40 is essentially responsible for sending and receiving voice or data communications to and from the vehicle, i.e., wirelessly to and from the rest of the communications system 10. As such, it comprises a Telematics controller 46 to organize such communications, and a network access device (NAD) 42 which include a wireless transceiver. Although shown as separate components, one skilled in the art will recognize that aspects of the head unit 50 and the Telematics control unit 40, and components thereof, can be combined or swapped.

FIG. 3 illustrates an idealized top view of a vehicle 26 showing the seating positions of four vehicle occupants 102a-d. In this embodiment, a user interface 51 (see FIG. 2) incorporates a push-to-talk switch 100a-d (part of a keypad 72) for each vehicle occupant. The push-to-talk switches 100a-d may be incorporated into a particular occupant's armrest 104a-d, or elsewhere near to the occupant such as on the occupants door, or on the dashboard or seat in front of the occupant, or in the ceiling or roof lining of the vehicle. Also included is the directional microphone 106, which may be mounted to the roof of the vehicle 26. In this embodiment, when a particular occupant (say, the occupant in seat 102b) presses their associated push-to-talk switch 100b, the directional microphone 106 is quickly steered in the direction of the pushed switch 100b, or more specifically, in the direction of the occupant 102b who pushed the switch. This is administered by the controller 56 in the head unit 50, which contains logic to map a particular switch 100a-d to a particular microphone direction in the vehicle. Even though the directionality of the microphone 106 may not be perfect and may pick up sounds or voices other than those emanating from the passenger in seat 102(b), this embodiment will keep such other ambient noises and voices to a minimum, so that the second vehicle will preferentially only hear the occupant who is contacting them.

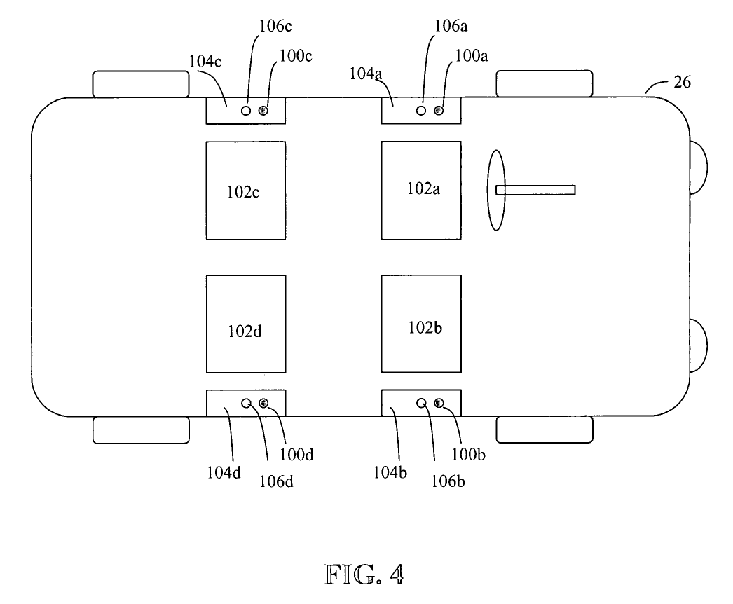

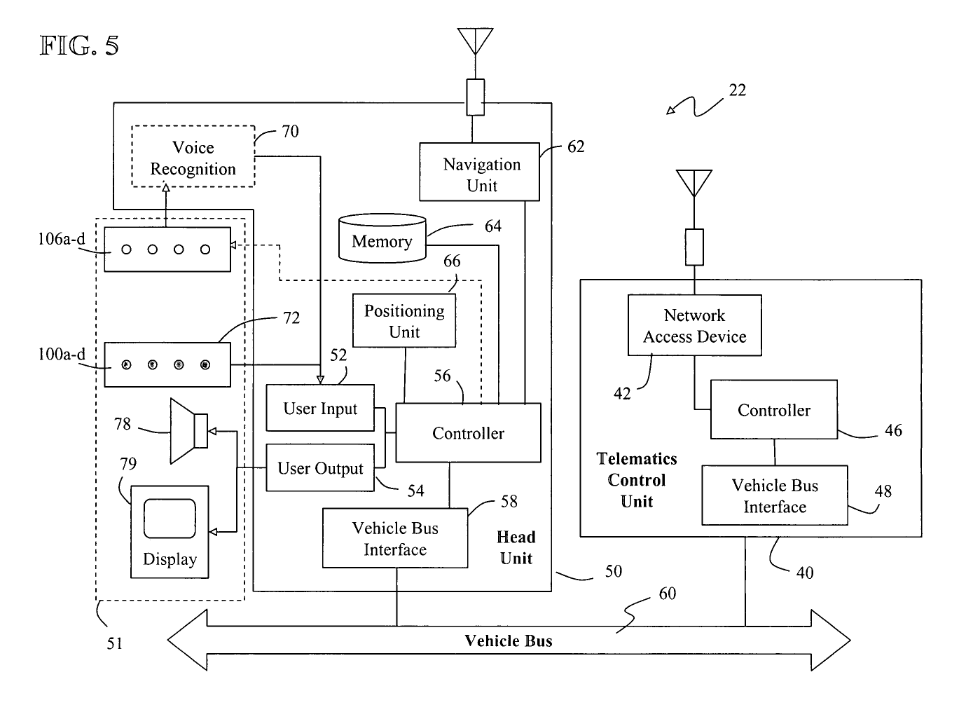

FIGS. 4-5 illustrate an alternative embodiment designed to achieve the same benefits of the system of FIG. 3. In this embodiment, microphones 106a-d are associated with each passenger seat 102a-102d, and which again may be incorporated into a particular occupant's armrest 104a-d, or elsewhere near to the occupant such as on the occupants door, or on the dashboard or seat in front of the occupant. In this embodiment, when a particular user presses his push-to-talk switch (e.g., 100b), the controller 56 will enable only that microphone (106b) associated with that push-to-talk switch. In short, only the microphone that is nearest to the occupant desiring to communicate is enabled, and thus only that microphone is capable of transmitting noise to the Telematics control unit 40 for transmission to the reminder of the communications system 10. (In this regard, it should be understood that “enabling” a microphone for purposes of this disclosure should be understood as enabling the microphone to ultimately allow audio data from that microphone to be transferred to the system for further transmission to another recipient. In this regard, a microphone is not enabled if it merely transmits audio data to the controller 56 without further transmission). Again, this scheme helps to keep other occupant's voices and other ambient noises from being heard in the second vehicle. In a sense, and in contrast to the embodiment of FIGS. 2 and 3, the embodiment of FIGS. 4 and 5 electronically steers a microphone array instead of physically steering a single physical microphone.

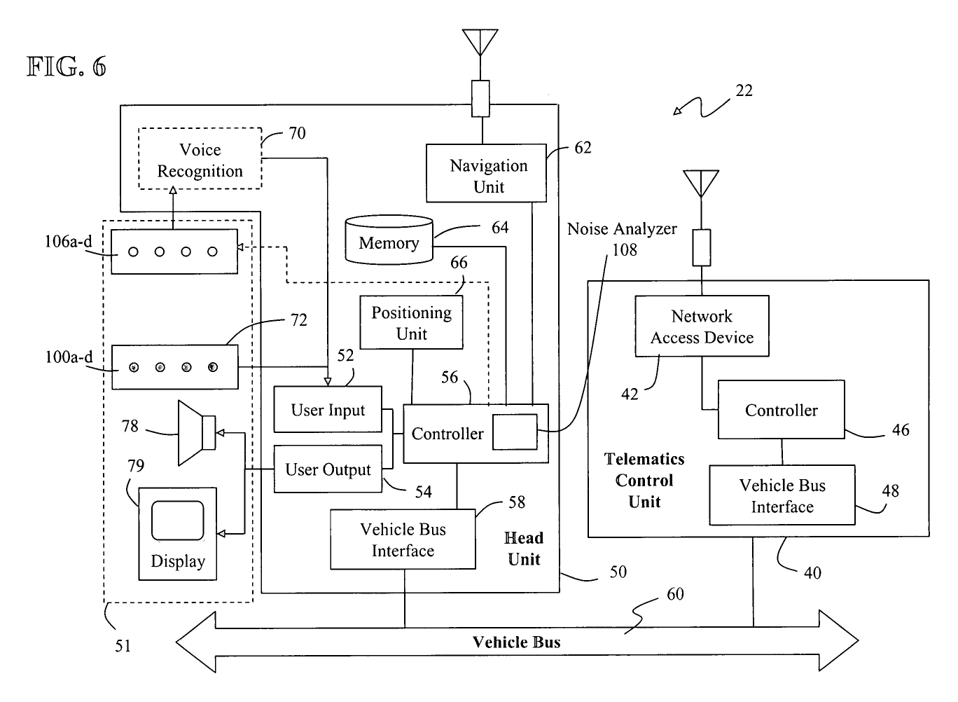

In an alternative embodiment, enablement of a particular microphone need not be keyed to the pressing of a particular push-to-talk switch 100a-d. Instead, each of the microphones may detect the noise level at a particular microphone 106a-d, and enable only that microphone having the highest noise level. In this regard, and referring to FIG. 6, the controller 56 may be equipped with a noise analyzer module 108 to assess which microphone is receiving the highest amount of audio energy. From this, the controller 56 may determine which occupant is likely speaking, and can enable only that microphone. Of course, this embodiment would not necessarily keep other speaking occupants from being heard, as a loud interruption could cause another's occupants microphone to become enabled.

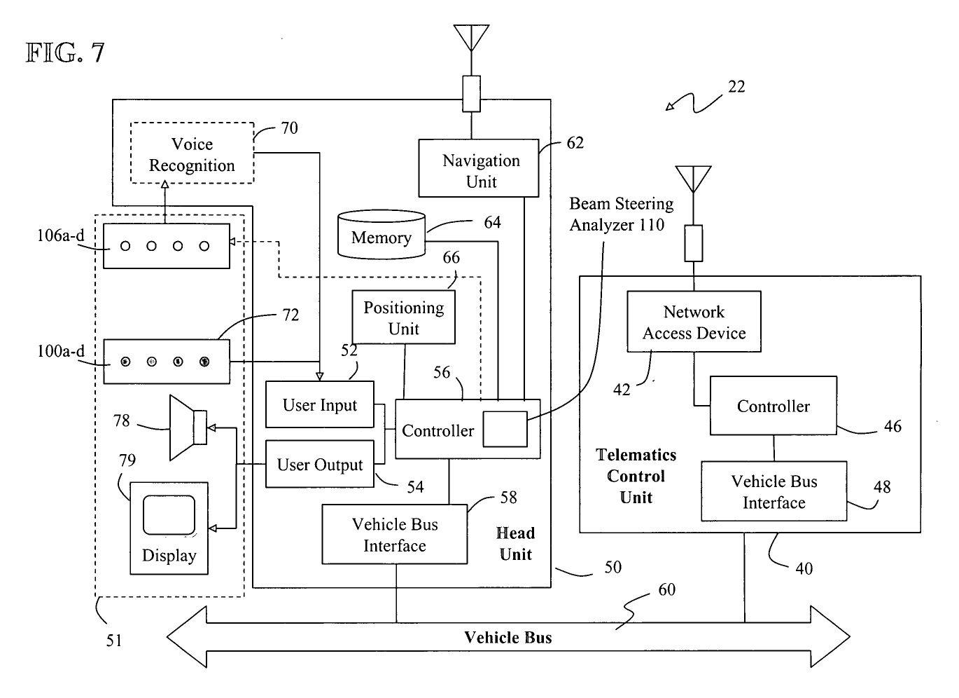

In still another alternative embodiment, beam steering may be used with the embodiments of FIGS. 4 and 5 to enable only the microphone 106a-d of the occupant which is speaking, without the necessity of that occupant pressing his push-to-talk switch 100a-d. Beam steering, as is known, involves assessing the location of an audio source from assessment of acoustics from a microphone array. Thus, and referring to FIG. 7, the controller 56 may be equipped with a beam steering analyzer 110. The beam steering analyzer 110 essentially looks for the presence of a particular audio signal and the times at which that signal arrives at various microphones 106a-d in the array.

For example, suppose the occupant in seat 102b is speaking. Assume further for simplicity that that occupant is basically equidistant from microphones 106a and 106d, which are directly to the left of and behind the occupant. When the occupant speaks, the beam steering analyzer 110 will see a pattern in the occupants speech from microphone 106b at a first time, and will see that same pattern from microphones 106a and 106d at a later second time, and then finally will see that same pattern from microphone 106c (the furthest microphone) at a third later time. As is known, such assessment of the relative timings of the arrival of the speech signals at the various microphones 106a-d can be performing using convolution techniques, which attempt to match the audio signals so as to minimize the error between them, and thus to determine a temporal offset between them. In any event, from the arrival of the speech at these different points in time, .the beam steering analyzer will infer that the occupant speaking must be located in seat 102b, and thus enable microphone 106b for transmission accordingly. This approach may also be used in conjunction with a physically steerable microphone located on the roof of the vehicle 26 to compliment the microphones 106a-d, or the microphones 106a-d may only be used to perform beam steering, with audible pick up being left to the physically steerable microphone.

The foregoing embodiments are useful in that they provide means for organizing the communication in the first vehicle by emphasizing speech by occupants intending to speak to the second vehicle, while minimizing speech from other occupants. This makes the received communications at the second vehicle less confused. However, the occupants in the second vehicle may still not know which of the occupants in the first vehicle is speaking to them. In this regard, communication between the vehicles is not as realistic as it could be, as if the occupants were actually conversing in a single room. Moreover, the second vehicle may desire ways to organize the communication it receives from the first vehicle, such as by not receiving communications for particular occupants in the first vehicle, such as children in the back seat.

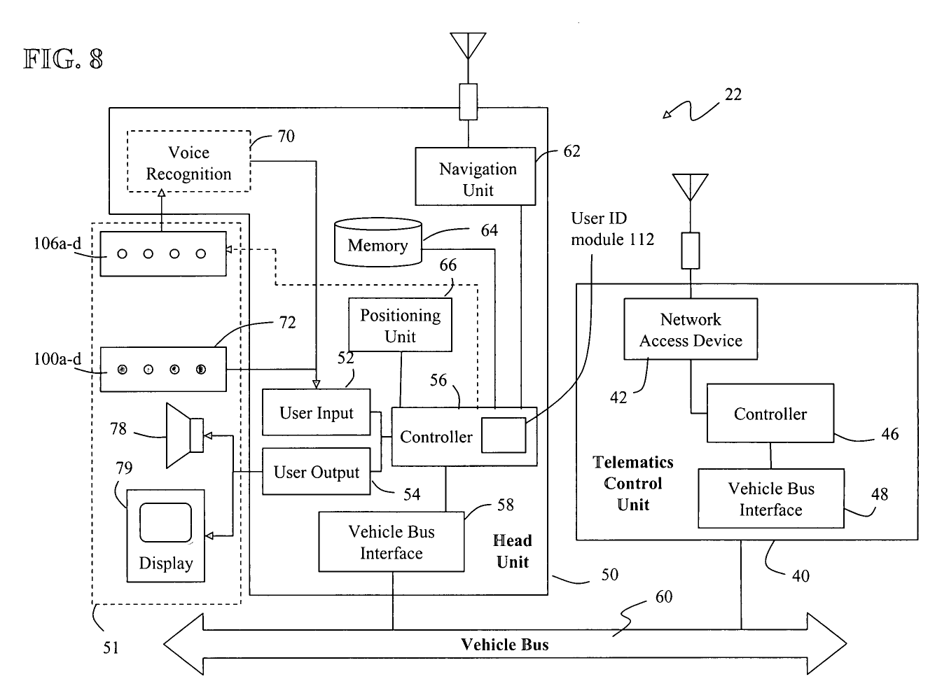

Accordingly, in a further improvement to the previously mentioned techniques, and as shown in FIG. 8, the controller 56 in the head unit 50 is equipped with a user ID module 112. The user ID module 112 has the capability to associate the occupants in the first vehicle with a user ID which can be sent to the second vehicle along with their voice data. In this way, with the addition of the user ID to the voice data, the occupants in the second vehicle can know which user in the first vehicle is speaking. Moreover, the user ID, or an associated user handle, may be used in reporting to other users, via display 79, the person who is speaking.

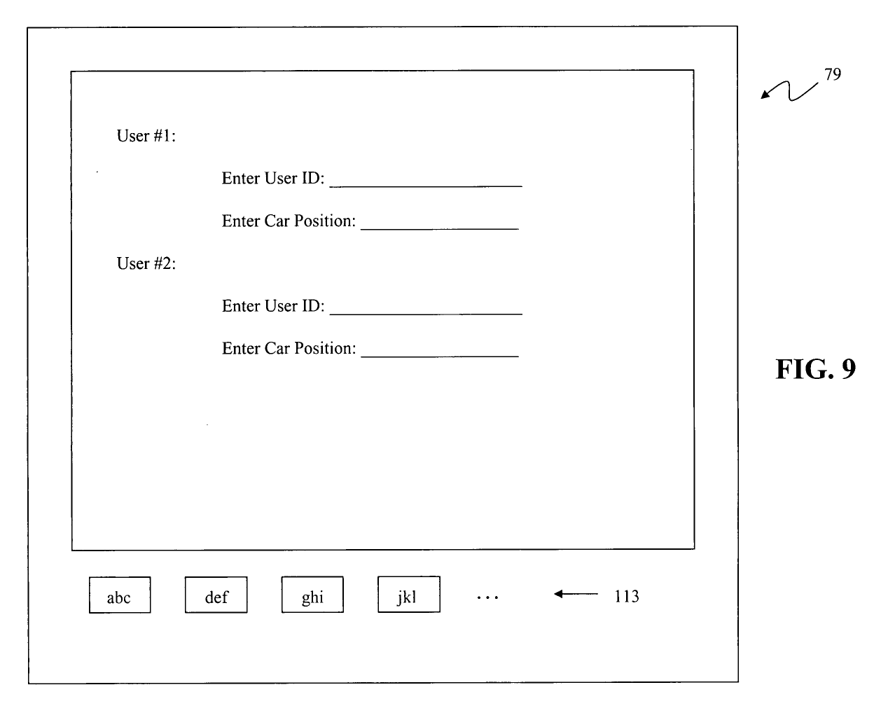

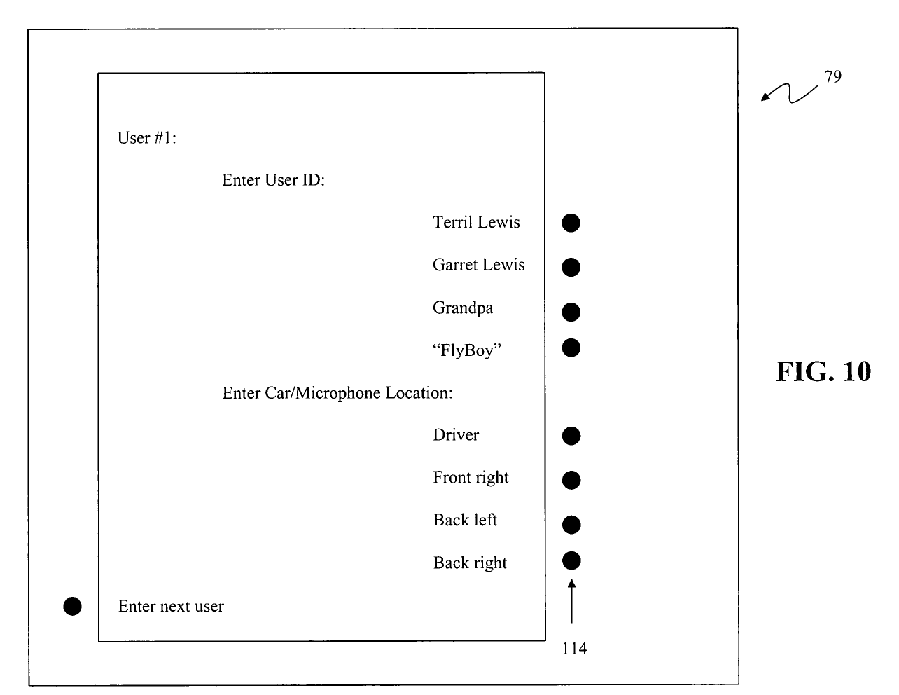

There are several ways in which the user ID module can associate particular occupants in the first vehicle with their user IDs. Regardless of the method used, it is preferred that such association be established prior to a trip in the first vehicle, such as when the occupants first enter the vehicle, although the association can also be established mid-trip. FIG. 9 shows one method in the form of a menu provided on the display 79 in the first vehicle's user interface 51. In this example, the various occupants in the first vehicle can enter their name and seat location by typing it in using switches 113 on the user interface 51, which in this example would be similar to schemes used to enter names and numbers into a cell phone. Ultimately, once entered, the association between an occupant's user ID and his location in the vehicle is stored in memory 64. In another embodiment, as shown in FIG. 10, previously entered user IDs and seat locations stored in memory 64 are retrieved and displayed to the user for selection using switches 114 on the user interface 51. In a further embodiment, the user ID is set by a user with a key fob. A key fob is a type of security device with built-in authentication mechanisms.

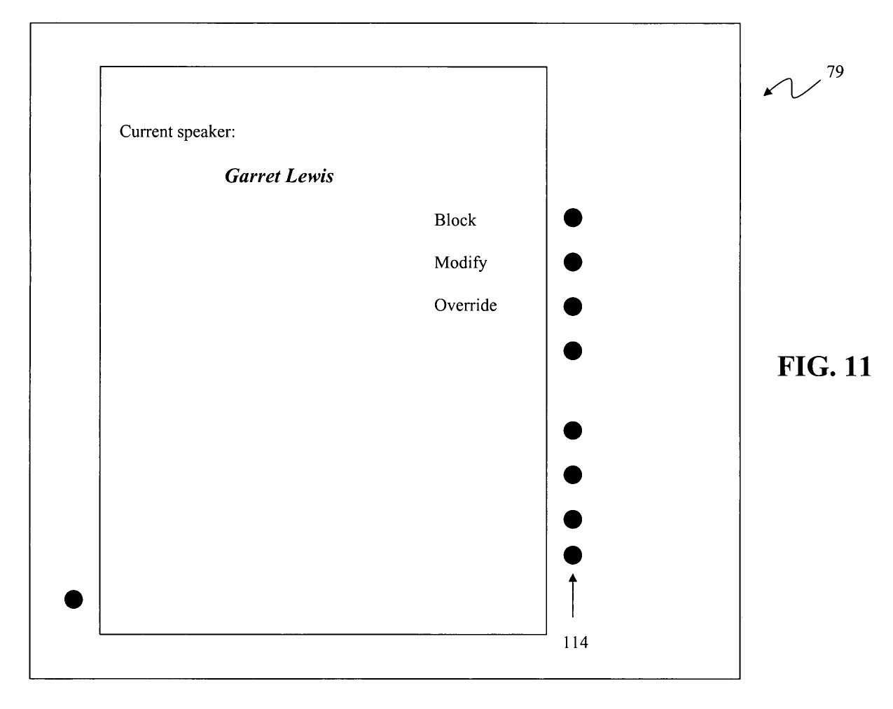

Once associated, the controller 56 knows, based on engagement of a particular microphone 106a-d (FIGS. 4-7) or the orientation of a physically steerable microphone (FIGS. 2-3), the user ID for the present speaker in the first vehicle. Accordingly, the controller associates that user ID with the voice data and sends them to the Telematics control unit 40 for transmission to the second vehicle. In a preferred embodiment, the user ID accompanies the voice data as a data header in the data stream, and one skilled in the art will recognize that several ways exists to create and structure a suitable header. Once received at the second vehicle, the user ID is stripped out of the data stream at the second vehicle's controller 56, and is displayed on the second vehicle's display 79 at the same time the voice data is broadcast through the second vehicle's speakers 78 (see FIG. 11). Accordingly, communications from the first vehicle are made more clear in the second vehicle, which now knows who in the first vehicle is speaking at a particular time.

In an alternative embodiment, the user, instead of the system, sends his user ID. In this embodiment, the head unit 50 does not associate a particular microphone or seat location with a user ID. Rather, the speaking user affirmatively sends his user ID, which may constitute the pressing of a switch or second switch on the user interface 51. Alternatively, schemes could be used such as a push-to-talk switch capable of being pressed to two different depths or hardnesses, with a first depth or hardness establishing push-to-talk communication, and further pressing to a second depth or hardness further sending the speaker's user ID (which could be pre-associated with the switch using the techniques disclosed earlier).

In yet another embodiment, the user ID is associated with a particular occupant in the first car via a voice recognition algorithm. In this regard, voice recognition module 70 (which also may constitute part of the controller 56) is employed to process a received voice in the first vehicle and to match it to pre-stored voice prints stored in the voice recognition module 70, which can be entered and stored by the occupants at an earlier time (e.g., in memory 64). Many such voice recognition algorithms exist and are useable in the head unit 50, as one skilled in the art will appreciate. When a voice recognition module 70 is employed, communications are made more convenient, as an occupant in the first vehicle can simply start speaking, perhaps by first speaking a command to engage the system. Either way, the voice recognition algorithm identifies the occupant that is speaking, and associates that occupant with his user ID, and transmits that occupant's voice data and user ID data as explained above.

Once the user ID is transmitted to the second vehicle, the occupants of the second vehicle can further tailor communications with the first vehicle. For example, using the second vehicle's user interface, the occupants of the second vehicle can cause their user interface to treat communications differently for each of the occupants in the first vehicle. For example, suppose those in the second vehicle do not wish to hear communications from a particular occupant in the first vehicle, perhaps a small child who is merely “playing” with the communication system and confusing communications or irritating the occupants of the second vehicle. In such a case, the user interface in the second vehicle may be used to block or modify (e.g., reduce the volume of) that particular user in the first vehicle, or to override that particular user in favor of other users in the first vehicle wishing to communicate. Thus, the occupants in the second vehicle can store the suspect user ID in its controller 56, or in the server 24 if network based, along with instructions to block, modify, or override data streams having the user's user ID in its header. Such blocking, modifying, or overriding can be accomplished in several different ways. First, it can be affected off-line, i.e., prior to communications with the first vehicle or prior to a trip with the first vehicle if prior communication experiences with the first vehicle or its passengers suggests that such treatment is warranted. Or, it can be affected during the course of communications. For example, and referring to FIG. 11, the second vehicle's display 79, as well as displaying the current speaker's user ID, can contain selections to block, modify, or override the particular displayed user. Again, several means of affecting such blocking, modifying, or overriding functions are capable at the second vehicle's user interface, and that method shown in FIG. 11 is merely illustrative.

If desirable, blocking, modifying, or overriding of a particular user can be transmitted back to the user interface in the first vehicle to notify the occupants in the first vehicle as to how communications have been modified, which might keep certain occupants in the first vehicle from attempting to communicate with the second vehicle in vain.

While the foregoing techniques and improvements will improve inter-vehicle communications, further improvements can make their communications more realistic, in effect by simulating communications to mimic the experience of all participants communicating in a single room to the largest extent possible. In such a realistic setting, communication participants are benefited from audible cues: certain speakers are heard from the left or right, and distant participants are heard more faintly than closer participants. Remaining embodiments address these issues.

Moreover, when a first user or vehicle 26a is participating in a push-to-talk (PTT) group with other vehicles, the server 24 can determine the distance of other vehicles in the PTT group. The server 24 may then prioritize the audio output to the first vehicle 26a based on the distance of the other vehicles in the PTT group. For instance, other users or vehicles in the PTT group that are closest to the first vehicle 26a may have greater priority than those that are further away from the first vehicle 26a.

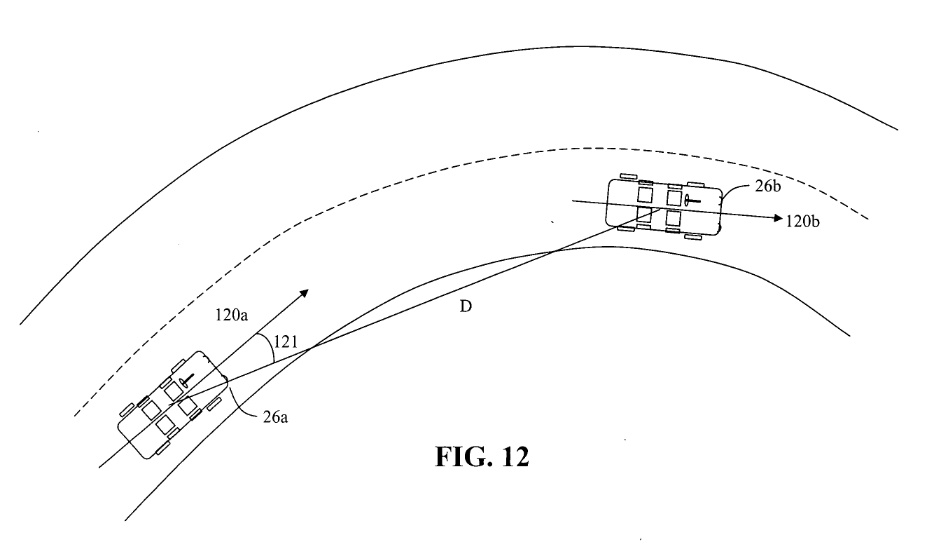

Referring to FIG. 12, two vehicles 26a and 26b are shown in voice communication using the communication system 10 disclosed earlier. At the instance in time shown in FIG. 12, the first vehicle 26a is traveling at a trajectory of 120a while the second vehicle is traveling at a trajectory of 120b. The vehicles are separated by a distance D. Moreover, the second vehicle 26b is positioned at an angle 121 with respect to the trajectory 120a of the first vehicle, what is referred to herein as the angular orientation between the vehicles.

Of course, as they drive, the distances and angular orientations of the vehicles will change. Parameters necessary to compute these variables may be computable by the head units 50 in the respective vehicles or by the server 24, if the system is network based. As discussed earlier, the head units 50 of the vehicles include navigation units 62 which receive GPS data concerning the location (longitude and latitude) of each of the vehicles 26a, 26b. Additionally, the head units 50 can also comprise positioning units 66 which determine the trajectory or headings 120a and 120b of each of the vehicles (e.g., so many degrees deviation from north, etc.). This data can be shared between the two vehicles when they are in communication by including such data in the header of the data stream, in much the same way that the user ID can be included. Alternatively, the data may be shared centrally at the server 24. When location data is shared, the distance D and angular orientation 121 between them can be computed. Distance D is easily computed, as the longitude and latitude data can essentially be subtracted from one another. Angular orientation 121 is only slightly more complicated to compute once the first vehicle's trajectory 120a is known. Both computations can be made by the controllers 56 which ultimately receive the raw data for the computations.

From this distance and angular orientation data, communications between the two vehicles can be made more realistic and informative by adjusting the output of the user interfaces in the vehicles 26a and 26b in different ways.

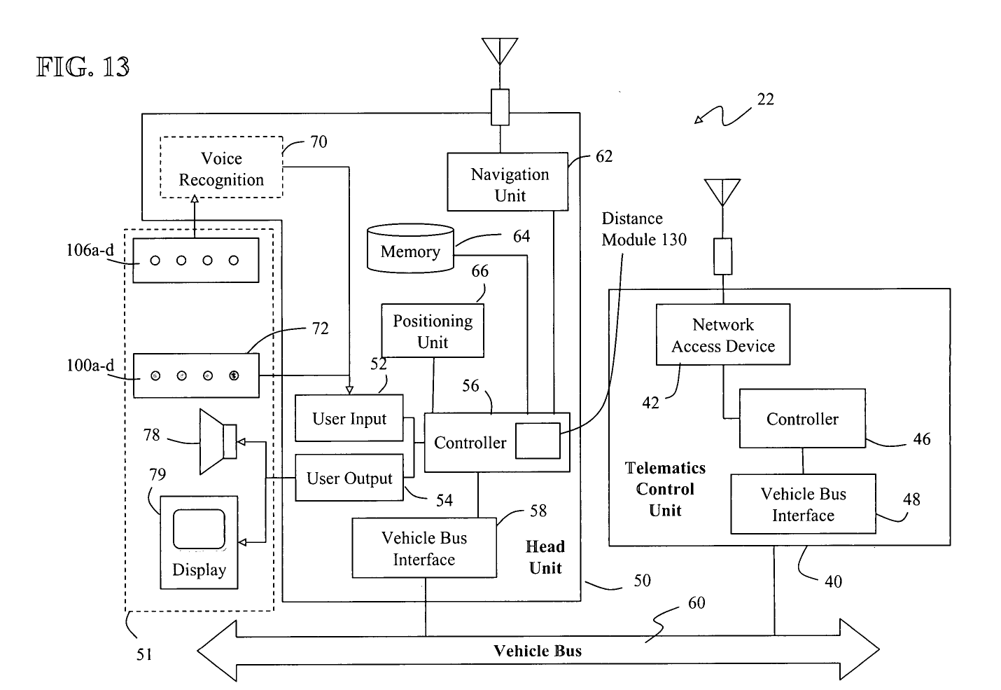

For example, computation of the distance, D, can be used to scale of the volume of the voices of occupants in the second vehicle 26b that are broadcast through the speakers 78 in the first vehicle 26a, such that the broadcast volume is high when the vehicles are relatively near and lower when relatively far. This provides the occupants an audible cue indicative of the distance between them. Referring to FIG. 13, this distance computation and scaling of volume is accomplished by a distance module 130 in the controller 56, or many be done centrally in the server 24 and the results communicated to each vehicle 26a, 26b. Moreover, as mentioned above, when a first user or vehicle 26a is participating in a push-to-talk (PTT) group with other vehicles, the audio output in the vehicle may be prioritized based on the distance of the other vehicles in the PTT group. For instance, other users or vehicles in the PTT group that are closest to the first vehicle 26a may have greater priority than those that are further away from the first vehicle 26a.

Such a distance/volume-scaling or volume prioritization scheme can be modified at the user interfaces 51 to suit user preferences. For example, the extent of volume scaling, volume priority, or the distance over which it will occur, etc. can be specified by the vehicle occupants.

In another modification used to indicate distance, the distance module 130 can modify the audio signal sent to the speaker in other ways. For example, instead of reducing volume, as the second vehicle 26b becomes farther away from the first vehicle 26a, the distance module 130 can add increasing level of noise or static to the voice communication received from the second vehicle. This effect basically mimics older style CB analog communication system, in which increasing levels of static will naturally occur with increased distance. In any event, again this scheme provides occupants in the first vehicle an audible cue concerning the relative distance between the two communicating vehicles.

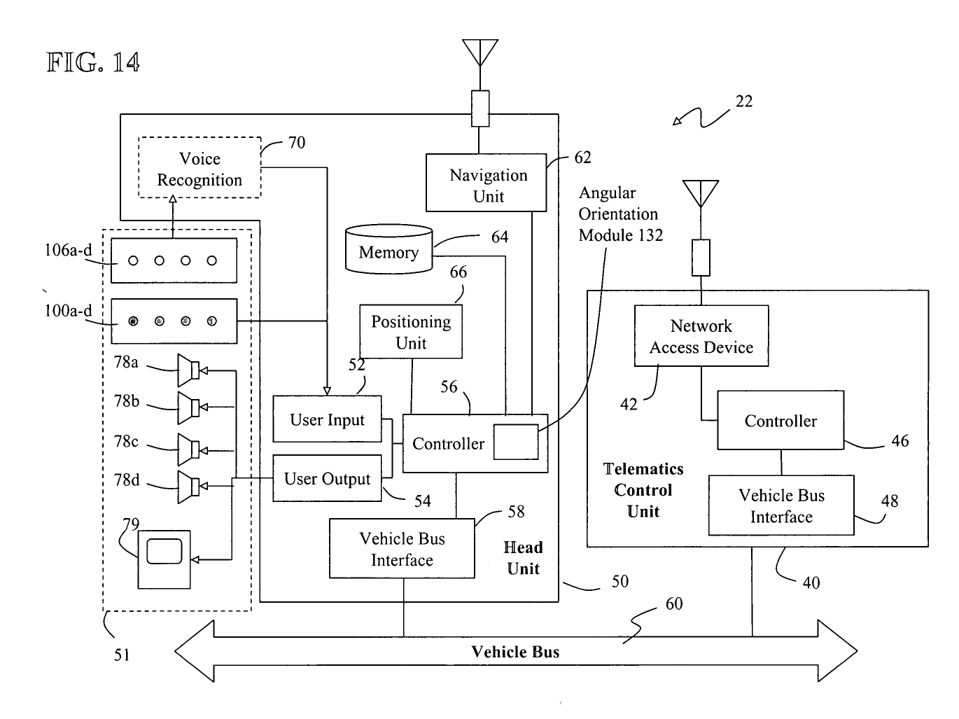

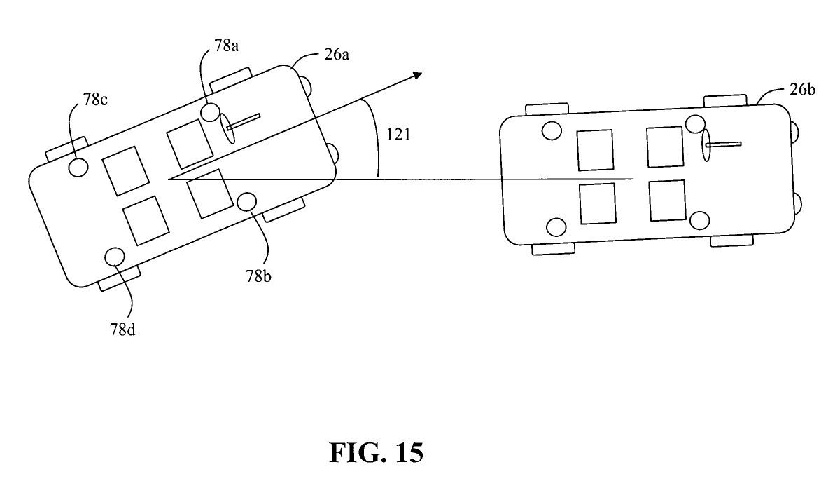

In another modification to make communications more realistic and informative, the speakers 78 within a particular vehicle can be selectively engaged to give its occupants a relative sense of the location of the second vehicle. In one embodiment, this scheme relies on computation of an angle 121, i.e., the angular orientation of the second vehicle 26b relative to the first 26a, as may be accomplished by the incorporation of an angular orientation module 132 to the controller 52, as shown in FIG. 14. Alternatively, the angular orientation module 132 may be network based and located in the server 24. In any event, assume for example that module 132, on the basis of location information from the two vehicles 26a and 26b and the heading 120a of the first vehicle, computes an angle 121 of 30 degrees, as shown in FIG. 15. Knowing this angle, the angular orientation module 132 can individually modify the volume of each of the speakers 78a-d in the first vehicle 26a, with speakers that are closest to the second vehicle 26b having louder volumes and speakers farther away from the second vehicle having lower volumes. For example, for the 30 degree angle of FIG. 15, the angular orientation module 132 may provide the bulk of the total energy available to drive the speakers to speaker 78b (the closest speaker), with the remainder of the energy sent to speaker 78a (the second closest speaker). The remaining speakers (78c and 78d) can be left silent or may be provided some minimal amount of energy in accordance with user preferences. Were the angle 121 zero degrees, speakers 78a and 78b would be provided equal energy; were it 90 degrees, speakers 78b and d would be provided equal energy, etc. In any event, through this scheme, the occupants in the first vehicle 26a would hear the voice communications selectively through those speakers that are closest to the second vehicle 26b, providing an audible cue as to the second vehicle's location relative to the first. Of course, the amount of available acoustic energy could be distributed to the speakers 78a-d in a variety of different ways while still selectively biasing those speakers closest to the second vehicle.

Essentially, the speaker volume adjustment techniques disclosed herein are akin to balancing (from left to right) and fading (from front to back) the volume of the speakers 78, a functionality which generally exists in currently-existing vehicle radios. In this regard, adjustment of the speaker volume may be effected by controlling the radio, which can occur through the vehicle bus 60, as one skilled in the art understands.

The foregoing speaker modification adjustment techniques can be combined. For example, as well as adjusting speaker 78 enablement on the basis of the angular orientation 121 between the two vehicles (FIG. 14), the volume through the engaged speakers can also be modified as a function of their distance (FIG. 13).

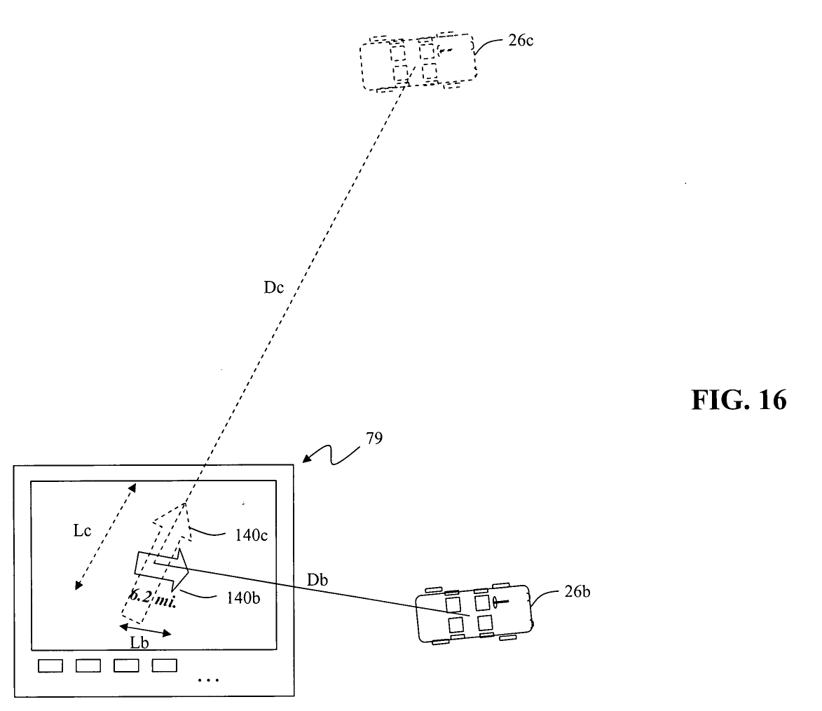

Still other modifications are possible using the system of FIG. 14. For example, instead of adjusting the speaker volumes, the angular orientation can be displayed on the display 79 of the user interface 51. As shown in FIG. 16, the angular orientation module 132 can be used to display an arrow 140b on the display 79 which points in the direction of the second vehicle 26b. Moreover, relative distance between the vehicles can also be displayed. For example, the second vehicle 26b is relatively near to the first vehicle at a distance of Db. Accordingly, the distance module 130 (FIG. 13) can adjust the length Lb of the displayed arrow 140 to shorten it to reflect this distance and well as orientation. By contrast, a third vehicle 26c is at a relatively large distance Dc, and accordingly the length Lc of the arrow 140c pointing to it is correspondingly longer. Instead of lengthening or shortening the arrow 140, the distance could merely be written near the arrow as alternative shown in FIG. 16.

In yet another embodiment, receipt of voice communications from the second vehicle is not broadcast throughout the entirety of the first vehicle, but is instead broadcast only through that speaker or speakers which are closest to the passenger in the first vehicle that initiated the communication. In this way, the conversation is selectively only broadcast to this initiating passenger, which can be determined by monitoring which of the push-to-talk switches in the first vehicle have been pressed, by electronic beam steering, or by other techniques. Once that passenger's location is determined, the control unit 56 will thereafter only route the communications through that speaker or speakers that are nearest to the passenger that initiated the conversation. Thereafter, if another passenger in the first vehicle engages in communication, the activated speaker can be switched.

The various techniques disclosed herein have been illustrated as involving various computations to be performed by the controller 56 in the head unit 50 within the vehicle. However, one skilled in the art will recognize that the processing and data storage necessary to perform the functions disclosed herein could be made at the server 24 (FIG. 1) as well.

Moreover, while largely described with respect to improving communications within vehicles, one skilled in the art will understand that many of the concepts disclosed herein could have applicability to communicative user interfaces not contained within vehicles.

Although several discrete embodiments are disclosed, one skilled in the art will appreciate that the embodiments can be combined with one another, and that the use of one is not necessarily exclusive of the use of other embodiments. Moreover, the above description of the present invention is intended to be exemplary only and is not intended to limit the scope of any patent issuing from this application. The present invention is intended to be limited only by the scope and spirit of the following claims.

1. A method of broadcasting communications in a vehicle having a plurality of speakers, comprising:
wirelessly coupling a control unit in the vehicle to a communication network to allow voice communications with another user coupled to the communication network;
determining data indicative of an angle between the trajectory of the vehicle and the position of the other user relative to the vehicle; and
selectively engaging the speakers in the vehicle to broadcast the voice communications in accordance with the determined angle so that the broadcast voice substantially correlates with the position of the user relative to the vehicle.

2. The method of claim 1, wherein the data indicative of an angle is computed using location data from the vehicle and the other user, and from the trajectory of the vehicle.

3. The method of claim 1, wherein the data indicative of an angle is derived at least from a compass in the vehicle.

4. The method of claim 1, wherein the data indicative of an angle is computed at the communication network and is transferred to the control unit.

5. The method of claim 1, wherein the data indicative of an angle is computed at the control unit.

6. The method of claim 1, wherein selectively engaging the speakers comprising balancing and fading to modulate the volume of the speakers.

7. The method of claim 1, further comprising the step of modifying the volume of the engaged speaker in a manner indicative of a distance between the vehicle and the other user.

8. A method of broadcasting communications in a vehicle having at least one speaker, comprising:
wirelessly coupling a control unit in the vehicle to a communication network to allow voice communications with another user coupled to the communication network;
determining a distance between the vehicle and the other user; and
providing through the at least one speaker the other user's voice, wherein the other user's voice is modified in a manner indicative of the distance to the other user.

9. The method of claim 8, wherein the modification of the other user's voice comprises scaling the volume of the other user's voice in inverse proportion to the distance.

10. The method of claim 8, wherein the modification of the other user's voice comprises adding a noise to the other user voice's voice, wherein the noise scales in volume in proportion to the distance.

11. The method of claim 10, wherein the noise comprises a simulation of static.

12. The method of claim 8, wherein the modification of the other user's voice is affected at the communication network and is transferred to the control unit.

13. The method of claim 8, wherein the modification of the other user's voice is affected at the control unit.

14. The method of claim 8, further comprising the step of selectively engaging the speakers in the vehicle in accordance with the angular orientation between the vehicle and the position of the other user.

15. A method of broadcasting communications in a vehicle having a plurality of speakers, comprising:
having a first user engage a user interface in the vehicle to enable the first user to wirelessly communicate with another user;
receiving the other user's voice at the vehicle; and
broadcasting the other user's voice through at least one of the plurality of speakers, wherein the broadcasted other user's voice is modified in a manner indicative of either the distance between the vehicle and the other user or the angular orientation between the vehicle and the other user.

16. The method of claim 15, wherein the distance is computed based upon the location of the vehicle and the other user.

17. The method of claim 15, wherein the angular orientation is computed based upon a trajectory of the vehicle and the location of the other user.

18. The method of claim 15, wherein the modification of the other user's voice is computed at a communication network and is transferred to the control unit.

19. The method of claim 15, wherein the modification of the other user's voice is computed at a control unit in the vehicle.

20. The method of claim 15, wherein the modification of the other user's voice comprises modifying the volume of the broadcasted other user's voice though at least one of the speakers.

21. The method of claim 15, wherein the modification of the other user's voice comprises selectively engaging certain speakers in the vehicle in accordance with the angular orientation.

22. The method of claim 15, wherein the modification of the other user's voice comprises adding a noise to the other user's voice.

23. The method of claim 22, wherein the noise comprises a simulation of static.

24. A method of broadcasting communications in a vehicle having a plurality of speakers, comprising:
having a first user engage a user interface in the vehicle to enable the first user to wirelessly communicate with another user;
receiving the other user's voice at the vehicle;
broadcasting the other user's voice through at least one of the plurality of speakers; and
displaying the location of the other user by a pointer which points to the location of the other user relative to the location of the vehicle.

25. The method of claim 24, wherein the pointer also indicates a distance of the other user.

26. The method of claim 25, wherein the distance is indicated by the length of the pointer.

27. The method of claim 25, wherein the distance is indicated in text in conjunction with the pointer.

28. The method of claim 24, wherein the pointer points in accordance with an angular orientation between the vehicle and the other user.

29. A method of broadcasting communications in a vehicle having a plurality of speakers, comprising:
having a first user in the vehicle establish a wireless voice communication with a second user;
receiving the second user's voice data at the vehicle;
determining the location of the first user in the vehicle; and
broadcasting the second user's voice data only through at least one of the plurality of speakers that is nearest to the first user.

30. The method of claim 29, wherein determining the location of the first user in the vehicle comprises assessment of which of a plurality of push-to-talk switches has been pressed by the first user.

31. The method of claim 29, wherein determining the location of the first user in the vehicle comprises using electronic beam formed steering.

32. The method of claim 29, wherein determining the location of the first user in the vehicle comprises receipt of data from the first user indicative of the position.
